(19) United States
(12) Patent Application Publication
(10) Pub. No.: US 2008/0315593 A1
(43) Pub. Date: Dec. 25, 2008

(54) WIND DAM

(76) Inventor: Paul Ducharme, Richmond Hill (CA)

Correspondence Address: HERMAN & MILLMAN, 141 ADELAIDE ST. WEST, SUITE 1002, TORONTO, ON, M5H 3L5, CA

(21) Appl. No.: 12/146,054

(22) Filed: Jun. 25, 2008

Related U.S. Application Data
(60) Provisional application No. 60/946,037, filed on Jun. 25, 2007.

(51) Int. Cl. F03D 9/00

(52) U.S. Cl. 290/55

(57) ABSTRACT

In one aspect a Wind Dam is provided comprising a Wind Capture Mechanism and a controller which is configured to be installed on buildings within cities. The wind capture mechanism comprises a Sail with Guide Wires, Wind Flaps an Exhaust Wind Guide a Center Mast a Spar and a wind vane. The Base Unit comprises a Heat exchanger a turbine a Sail Rotation mechanism a Gear mechanism a Rotor and a U Shaped Tube a Drain a Siphon tube and a Protective grill. The controller operates a control algorithm which uses sensor data to adjust controls which operate the wind dam. The Wind dam is specifically configured to be installed on building roofs within cities and to convert wind energy into heating or cooling or generate electricity. The Wind Dam may also be used to cancel building sway.

### FIELD OF THE INVENTION

The present invention relates generally to devices that capture wind energy and convert it for other uses, and more particularly to devices that capture wind energy and convert it for other uses, and which are appropriate for installation in an urban environment.

### BACKGROUND OF THE INVENTION

Devices that convert wind energy into electricity (i.e. wind generators) are well known and generally involve installation of a large rotor on a pedestal which is rotated by available wind (see FIG. 1) and thereby generates electricity. The traditional configuration of rotor based wind generators have several features which make them inappropriate for installation within populated areas as follows:

Typical wind generators include a large rotor which in the case of a catastrophic failure would pose a serious safety risk in an urban area.

Typical wind generators are traditionally used to generate electricity, which must then be consumed for various uses, such as heating or cooling of a building. Each step in the conversion process has inherent inefficiencies associated with it. Accordingly, it would be advantageous to reduce the number of steps in converting from wind energy to the final use.

Typical wind generators only operate when wind speeds are above a certain threshold, in order to overcome mechanical resistance that is inherently present.

Typical wind generators are installed at great distance from populated areas and thus suffer significant line losses when the generated electricity is transmitted to any use points that are in such populated areas.

Typical wind generators are relatively expensive to manufacture and require a great deal of material, manufacturing and installation costs.

### SUMMARY OF THE INVENTION

In one embodiment, the current invention is directed to a wind energy conversion device that does not incorporate large-scale rotors, thereby posing a reduced risk to life or property in the event of a catastrophic failure.

In another embodiment, the current invention is directed to a device that converts wind energy into cooling or heating with relatively high efficiency, for example without an intermediate step of converting to electricity.

In another embodiment, the current invention is directed to a wind energy conversion device that operates in a relatively greater range of wind conditions, and can deliver at least some cooling or heating in virtually any wind conditions.

In another embodiment, the current invention is directed to a wind energy conversion device that is positioned proximate the use point for the energy, which results in reduced losses associated with transmission distance, relative to typical wind generators, which are located relatively remotely from high population density areas.

In another embodiment, the current invention is directed to a wind energy conversion device that is relatively inexpensive, at least in part by being mounted on the roof of a building, thereby reducing the expense associated with erecting a pedestal to bring it to an altitude of greater wind velocity.

### BRIEF DESCRIPTION OF THE DRAWINGS

Various advantages, features and characteristics of the present disclosure, as well as methods, operation and functions of related elements of structure, and the combination of parts and economies of manufacture, will become apparent upon consideration of the following description and claims with reference to the accompanying drawings, all of which form a part of this specification.

FIGS. 1a and 1b are elevation views of prior art wind generator devices.

FIG. 2 is a diagram illustrating the installation of a wind dam in accordance with an embodiment of the present invention, on the roof of a building.

FIG. 3 is an elevation view of the structure and components of the wind dam shown in FIG. 2.

FIG. 4 is an elevation view of the structure of the wind capture mechanism of the wind dam shown in FIG. 2.

FIG. 5 is an elevation view of some components of the wind capture mechanism shown in FIG. 4, including a sail and a set of guide wires used to retract or deploy the sail.

FIG. 6 is a diagram illustrating wind release flaps which are used to stabilize the wind dam shown in FIG. 2, and the subcomponents that make up the wind release flaps.

FIG. 7 is a diagram illustrating a sway dampening mechanism that is included in the wind dam shown in FIG. 2.

FIG. 8 is a diagram illustrating a heat exchanger which is included in the wind dam shown in FIG. 2.

FIG. 9 is a diagram illustrating a gear mechanism which selectively directs mechanical energy to the heat exchanger shown in FIG. 8 or to a turbine.

FIG. 10 is a perspective view of a base rotation mechanism used to orient the wind dam.

FIG. 11 is a diagram illustrating a control system for the wind dam shown in FIG. 2 including a controller and a plurality of sensors.

FIG. 12 is a control algorithm used by the controller shown in FIG. 11.

FIGS. 13a and 13b are diagrams illustrating configurations for a rotor that is included in the wind dam shown in FIG. 2.

FIG. 14 is an elevation view of a protective grill that is included in the wind dam shown in FIG. 2.

FIG. 15 is an elevation view of an exhaust wind guide that is included in the wind dam shown in FIG. 2, and wind flow therethrough.

### DETAILED DESCRIPTION OF THE INVENTION

In accordance with the present disclosure, a wind dam device is disclosed. The wind dam device includes a wind capture device which is used to trap wind and direct wind energy to the base unit which then converts the wind energy into mechanical energy which in turn is used to generate heating or cooling which is then used to heat or cool the building on which the wind dam is installed or generate electricity. The wind dam base comprises a Rotor attached to a turbine and/or heat exchanger via a gear mechanism which together are used to convert the wind energy into heating or cooling or optionally the turbine is used to generate electricity. The base of the wind capture device is configured such that it may be rotated under control of a controller in order to point the sail into the wind depending on the current wind direction. There is a protective grill at the base between the sail and the input of Rotor which protects the Rotor from damage due to objects which may inadvertently be drawn into the wind dam. At the exhaust of the Rotor there is a wind guide which is used to direct the exhaust wind to the rear of the sail, this mechanism is used to direct a flow of exhaust wind to the back of the sail which assists in balancing the stress on the sail. There is a Rudder attached to the wind guide which allows the controller to direct the exhaust wind to either side of the back of the sail. Along the surface of the sail there are various small wind flaps which open to allow wind pressure to be released, these are configured to keep the average flow of wind below a maximum and to prevent cavitations.

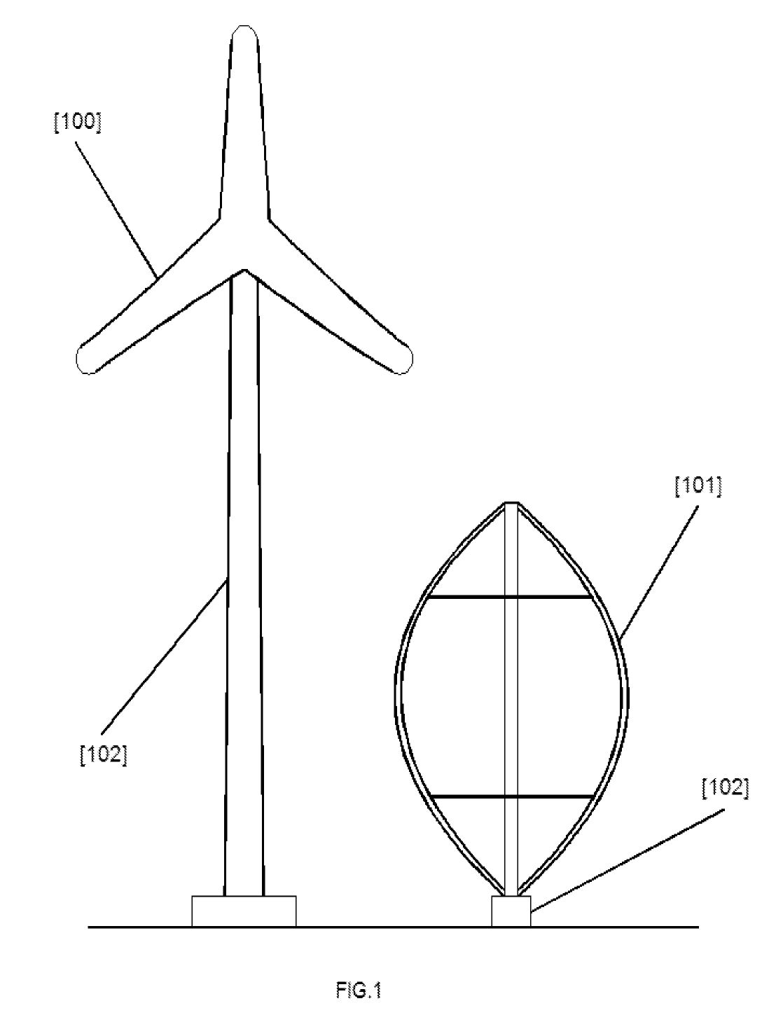

Referring to FIGS. 1a and 1b, two types of conventional wind generators are shown. Conventional wind generators require a large Rotor [100], [101] and are typically placed atop a pedestal [102]. These features make conventional wind generators relatively less appropriate for installation within urban areas.

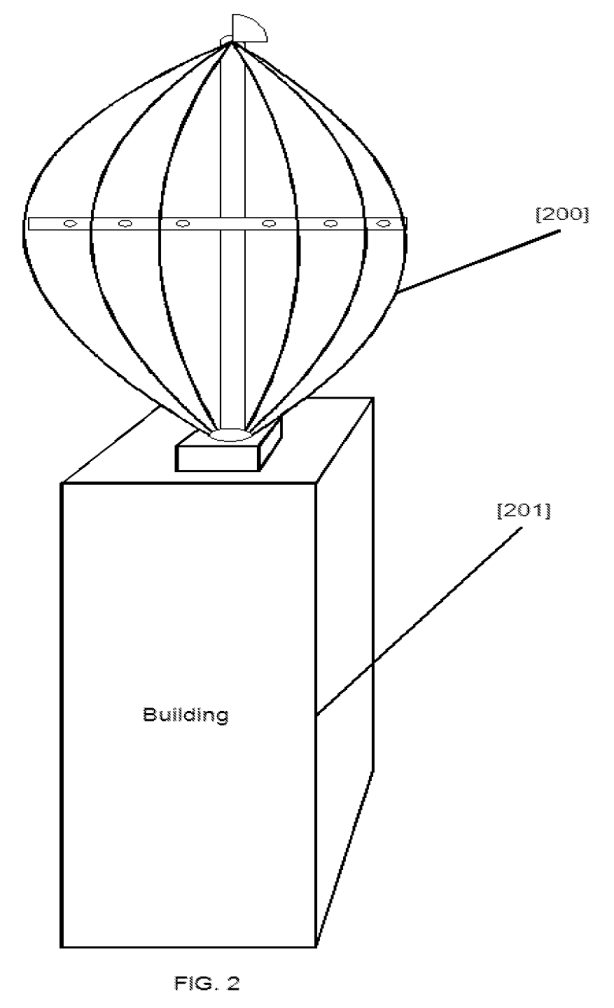

FIG. 2 illustrates a wind dam [200] in accordance with an embodiment of the present invention, installed on the roof of a building [201]. The building acts as a pedestal [102] for the wind dam [200] thus eliminating the cost of the pedestal [202] (FIGS. 1a and 1b) required in the conventional wind generator thus reducing cost. The wind dam [200] can be used to generate cooling or heating for the building and/or electricity. The selection of the building [201] may be done in such a way as to selectively position the wind dam [200] at a suitable position within a city taking into account nearby buildings and prevailing wind direction.

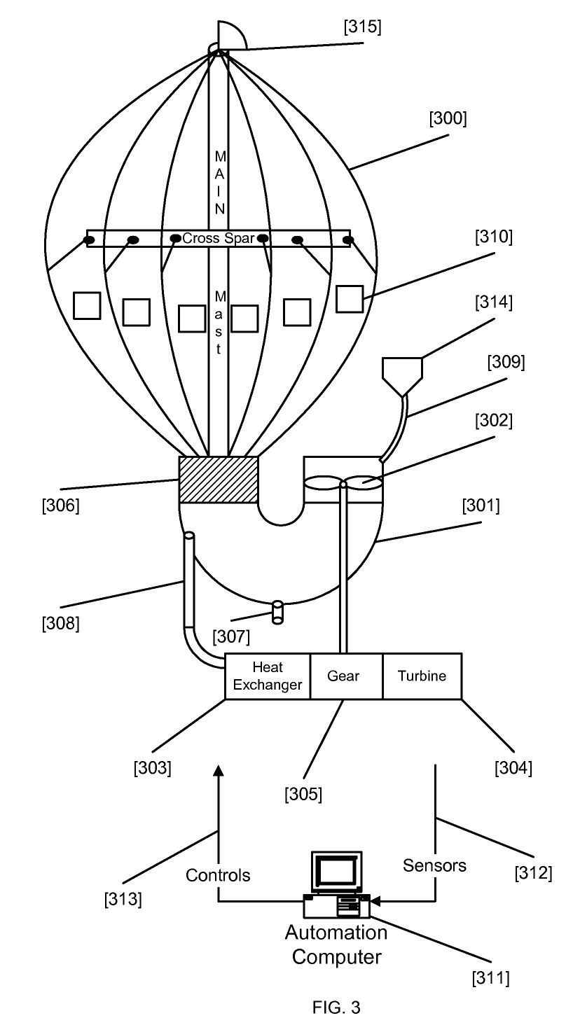

FIG. 3 illustrates the structure and components of a complete wind dam and the functional relation of the components to each other. Some of the component naming and terminology used in the following borrow from terminology analogous to that used in sailing ships. The sail [300] is used to trap and direct wind energy to the intake of the U shaped Tube [301] which directs the wind to the Rotor [302] which converts the wind energy into mechanical energy Mechanical energy in turn is used to operate the heat exchanger [303] or the turbine [304] via the gear mechanism [305]. The Heat exchanger is used to convert the mechanical energy into either heating or cooling which is used for air conditioning the building upon which the wind dam is installed. The turbine is used to convert the mechanical energy into electricity which may be used by the building's electrical system or feed back into the local power grid. The gear mechanism between the Rotor and the heat exchanger and turbine allows a variable amount of energy to be split between the heat exchanger or the turbine (i.e. at some times all or some of the energy may be converted into heating/cooling rather than electricity). The gear mechanism may also increase or decrease the resistance on the Rotor itself thus allowing the wind dam to draw more or less energy from the wind (i.e. in low wind cases the wind dam will draw less energy from the wind, in high wind cases the wind dam will draw more energy from the wind, this is done to prevent stalling in low wind cases). The intake to the Rotor includes a protective grill [306] which is used to deflect objects which may be accidentally trapped by the sail (i.e. this prevents large objects from damaging the rotor). There is a drain [307] at the bottom of the U shaped tube which is used to drain any water or small objects which may be caught in the wind dam. There is a wind siphon tube [308] used to siphon off wind and direct it to the Heat Exchanger, this portion of the wind energy may be used to provide forced air output to the heat exchanger. At the exhaust of the Rotor there is a wind guide [309] which directs the exhaust wind to the rear of the sail to create pressure on the rear of the sail to at least partially balance the air pressure on the front of the sail, thereby reducing the stress on the sail itself and allowing the sail to be manufactured with lighter material. There is a rudder [314] above the wind guide which can be pivoted under control of the controller to direct back pressure to either side of the sail. Along the sail there are various wind release flaps [310] which are placed strategically in such a way as to open and allow wind energy to escape in cases when the wind is too strong and to close when the wind is weak thereby maximizing the wind energy trapped in situations where the wind is weak, while providing an escape valve in situations where the wind is too strong. In this way, the wind flaps also play a part in a failsafe mechanism for the wind dam. The entire wind dam is controlled by controller [311], the main function of the controller is to monitor sensors [312] and actuate control [313] to control the orientation of the sail and to control the gear mechanism in order to achieve an optimal balance between heating/cooling and electricity generation depending on the building demand and available wind conditions. There are various sensors which provide the controller with information such as wind direction sensed by the wind vane [315], wind pressure, building status/demand state and there are various controls which the controller can actuate to control components of the wind dam.

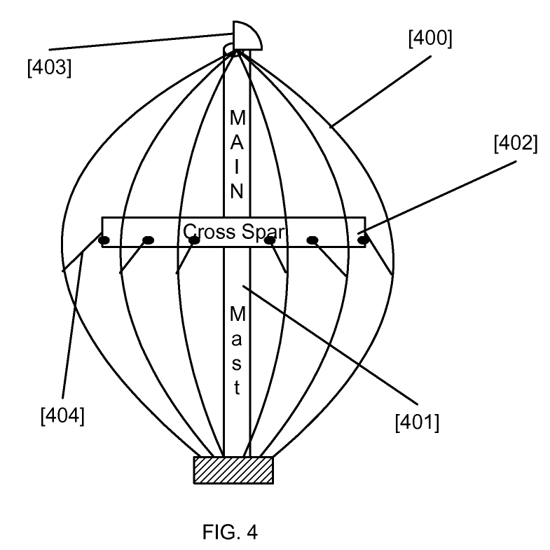

FIG. 4 illustrates the Wind Dam's wind capture mechanism which includes a Sail [400] which is attached to a main mast [401] and a cross spar [402], there is also a wind vane [403] above the central mast which is used to detect the wind direction and speed. Guide wires [404] run through the main mast and spar and are connected to the sail, the guide wires may be tightened to adjust the stress on the sail thus allowing the sail to be deployed or retracted. The wind capture mechanism is configured such that the sail may be retracted in cases where the wind may be too strong to keep the sail deployed i.e. the length of the guide lines can be varied in such a way as to pull the sail closer to the central mast. The center mast itself may be rotated in order to position the sail and spar perpendicular to the wind direction (Deployed) in order to maximize the sail's wind footprint or rotated to position the sail and spar parallel to the wind direction (Retracted) in order to minimize the sail's wind footprint.

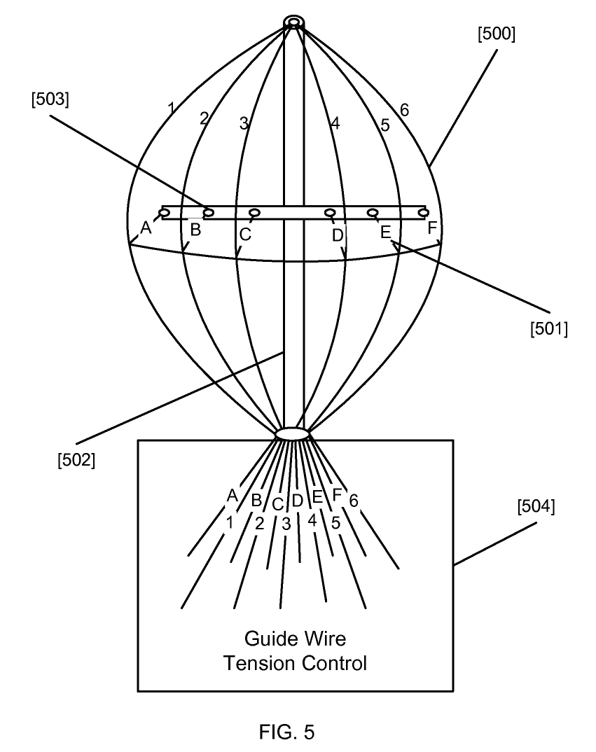

FIG. 5 is a diagram illustrating the sail [500] and guide wires [501]. The sail is constructed of canvas, nylon, plastic or similar fabrics and is suspended on the main mast [502] and spar [503] using guide wires. Guide wires {1, 2, 3, 4, 5, 6} travel from the base of the sail within the main mast to the top of the main mast and run along the outside of the sail, Guide wires {A, B, C, D, E, F} run from the base of the sail half way up within the main mast, within the spar and across through holes along the spar then connect to the sail body. The Guide wires can be loosened or tightened at the base of the sail by a [504] tension control system which allows the controller to adjust the guide wires thus allowing the sail to be deployed or retracted. The Guide wires provide a mechanism for controlling the shape of the sail. Stress Sensors at the base of the sail also allow the controller to detect the stress on the sail and make adjustments as desired.

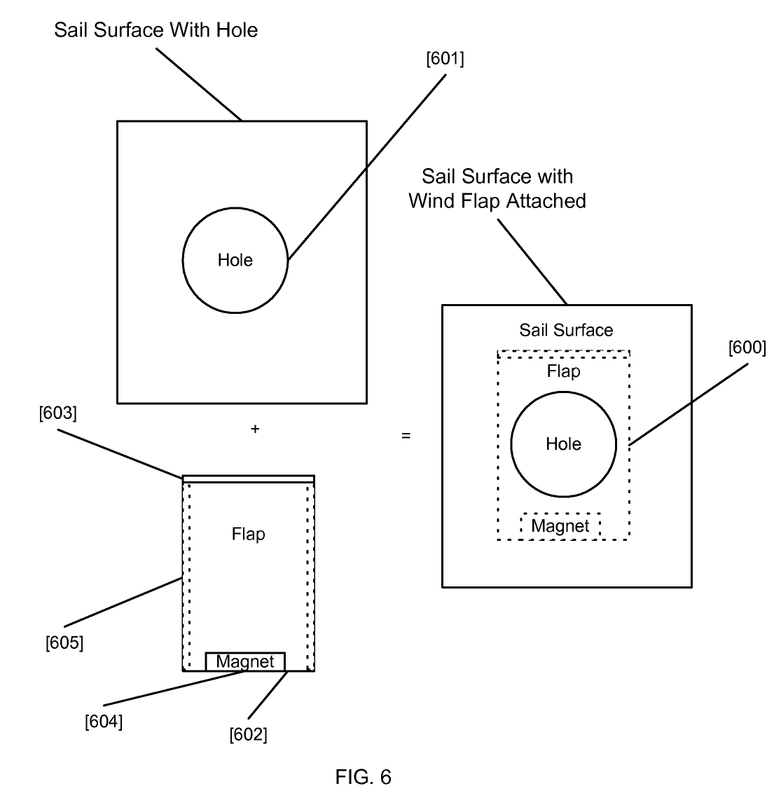

FIG. 6 illustrates the configuration of a wind release flap [600] which includes a hole [601] in the sail with a flap [602] attached to the rear of the sail. The flap is fastened at the top with a flexible hinge [603] and is held in place at the bottom by [604] magnets the sides of the flap are separated by stiffeners [605] build into the wind flap. When the wind pressure on the front of the sail exceeds the attractive force of the magnets the flap is forced open and air may flow through the hole in the sail to the rear of the sail. The release flaps are advantageous for several reasons. For example, they act as a release valve in the case where the wind is too strong thus relieving pressure on the sail. Additionally, the release flaps prevent cavitation (i.e. a situation where air collects at the front of the sail causing the wind to flow around the sail instead or being directed into the U shaped tube). Additionally, the release flaps provide a mechanism for balancing pressure across the sail; inhibiting lateral oscillation of the sail. Another function of the release flaps relates to the Fail Safe mechanism. It will be noted that there are more release flaps on one side of the sail then the other. If the controller fails or the rotating mechanism fails then the wind will naturally push on one side of the sail more than the other causing the sail to rotate until it is generally perpendicular to the direction of the wind, and is therefore not in an orientation that promotes wind collection.

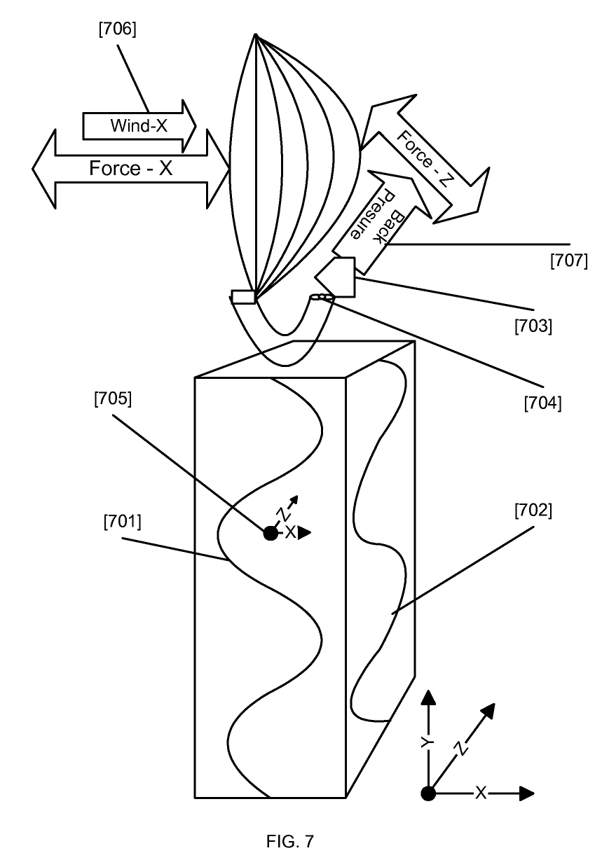

FIG. 7 illustrates a sway dampening mechanism which is used to detect building sway using a sway censor [705] which is positioned several floors below the roof and canceling building oscillation in either the X [701] or Z [702] direction (Y is vertical). The advantage of this is that by canceling building sway the wind dam will reduce the wear and tear experienced by the building structure due to wind gusting and in the event of an earth quake the sway canceling mechanism would reduce damage to the building. The sway canceling mechanism operates by first using the sway detector to detect the instantaneous building oscillation which travel along the building before it reaches the roof in the X and Z direction then dynamically adjusting the coupling mechanism [904] to increase or decrease resistance on the rotor [704] and thus impart a varying force on the building which is opposite to the direction of the win flow [706]. By adjusting the rudder [703] the wind dam can control backflow pressure in either the +Z or −Z directions thus imparting a force on the building which is perpendicular to the wind direction [707]. In this way the wind dam can anticipate building sway and by adjusting its control surfaces the wind dam can generate a force in the X and Z directions which is anti-phase to the direction of the building sway.

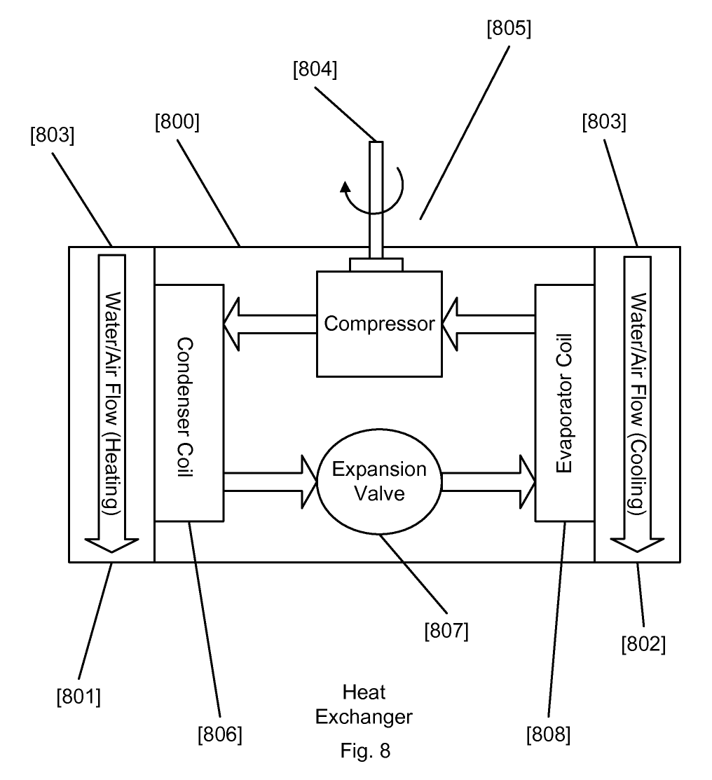

FIG. 8 is a diagram illustrating of the heat exchanger [800] which is used for heating [801] or cooling [802]. Mechanical energy from the Gear mechanism is transferred to the heat exchanger via the [804] Heat Exchanger Shaft. The mechanical energy is used to operate the Compressor [805]. The heat exchanger also includes a Condenser Coil [806], an Expansion Valve [807] and an Evaporator Coil [808]. The heat exchanger includes a wind siphon [803] which allows the heat exchanger to use a portion of the wind energy directly from the U shaped tube to be used in the case where forced air is used to deliver the heating/cooling to the building. In other cases the heating or cooling is conveyed by water flow through the heating or cooling elements of the heat exchanger.

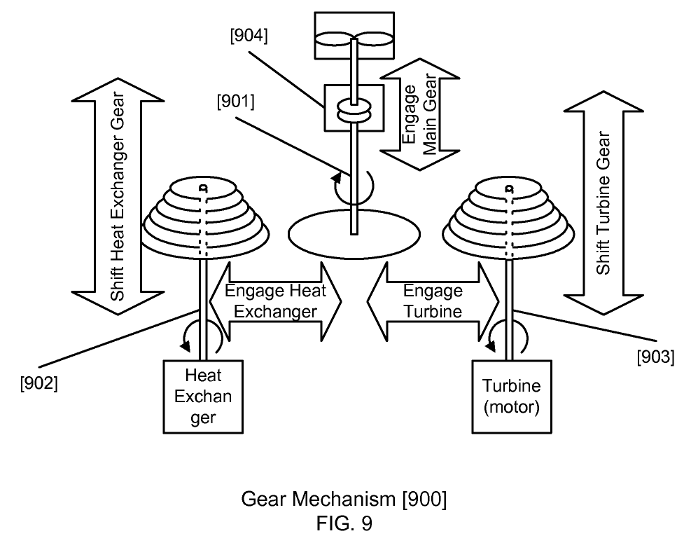

FIG. 9 is a diagram illustrating the gear mechanism [900] which permits selected gears to be engaged with different gear ratio adjustments to be performed under control of the controller. The 1^{st}, gear ratio controlled is the ratio of the main shaft [901] to the Heat Exchanger [902] which allows a variable amount of energy to be converted into heating or cooling. The 2^{nd} gear ratio control is the ratio between main shaft and the turbine [903]. There is a coupling mechanism [904] which allows the gear ratio between the main shaft and the Rotor to be varied or completely decoupled from the main shaft (i.e. this allows the Rotor to spin freely or to be variably connected to the main shaft). The coupling mechanism may also be varied dynamically in order to present more of less resistance to the wind, this has the effect of generating a force parallel to the direction of the wind. This parallel force is used by the dampening mechanism to cancel building oscillations (as described above in relation to FIG. 7). The heat exchanger itself is adjustable in that it may operate to convert the mechanical energy into either cooling or heating. The Gear mechanism may be operated in a combination of four modes.

In the 1^{st} mode mechanical energy from the Rotor will turn the main shaft which will turn the heat exchanger shaft which generates heating or cooling (Air conditioner mode).

In the 2^{nd} mode mechanical energy from the Rotor will turn the main shaft which will turn the turbine shaft causing the turbine to generate electricity as a generator (Electrical generator mode).

In a 3^{rd} mode electricity is applied to the turbine which is used as a motor will cause the turbine shaft to turn and this will cause the main shaft to turn and then turn the Rotor (Rotor Spin Up mode).

In a 4^{th} mode electricity is applied to the turbine which is used as a motor will cause the turbine shaft to turn and this will cause the heat exchanger shaft to turn and operate the heat exchanger (powered air conditioner mode).

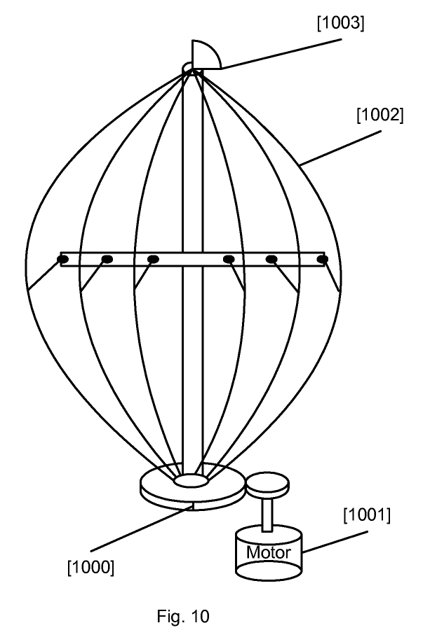

FIG. 10 is a diagram illustrating the base rotation mechanism [1000] used to point the wind dam. The Base rotation mechanism includes a motor [1001] which under control of the controller can rotate the sail [1002] in order to control the orientation of the sail relative to the wind direction. Note that there is a wind vane [1003] atop the sail which detects the wind direction.

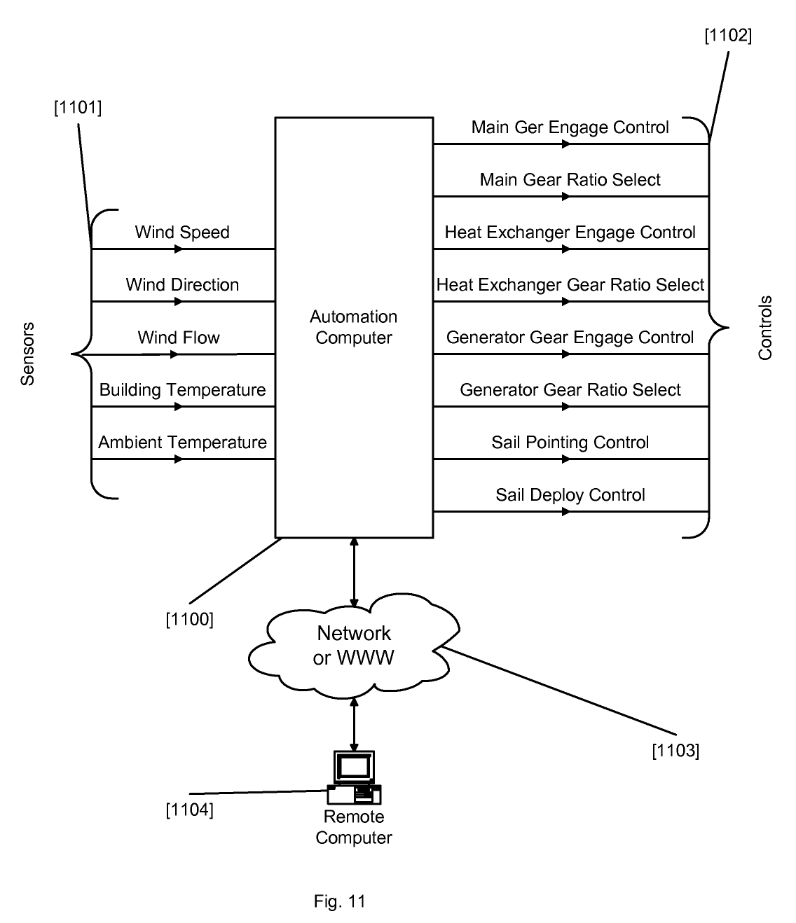

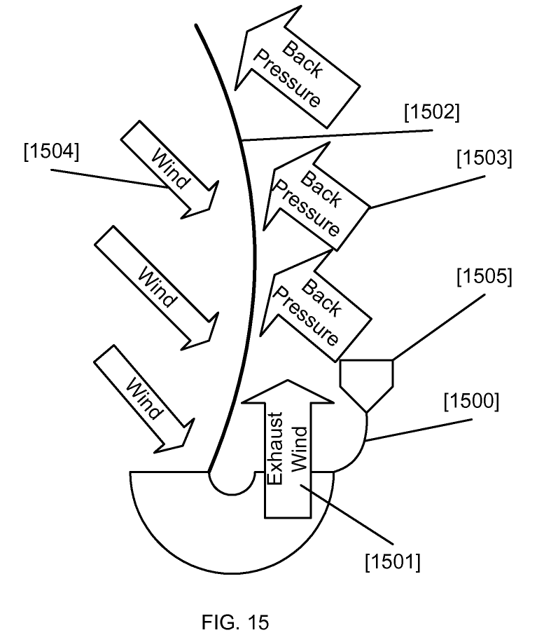

FIG. 11 is a diagram illustrating the controller [1100] and the sensors [1101] and controls [1102] which the controller uses to constantly monitor and adjust the wind dam. The controller operates autonomously but is connected to a network [1103] interface such that a remote computer [1104] can monitor and override the operations of the controller. One function of the Controller is to use the parallel and perpendicular force mechanism (see FIG. 9 and FIG. 15) to dampen oscillations of the building. This is a useful feature for canceling building sway (caused by the wind or earth movement) which may cause damage to the building.

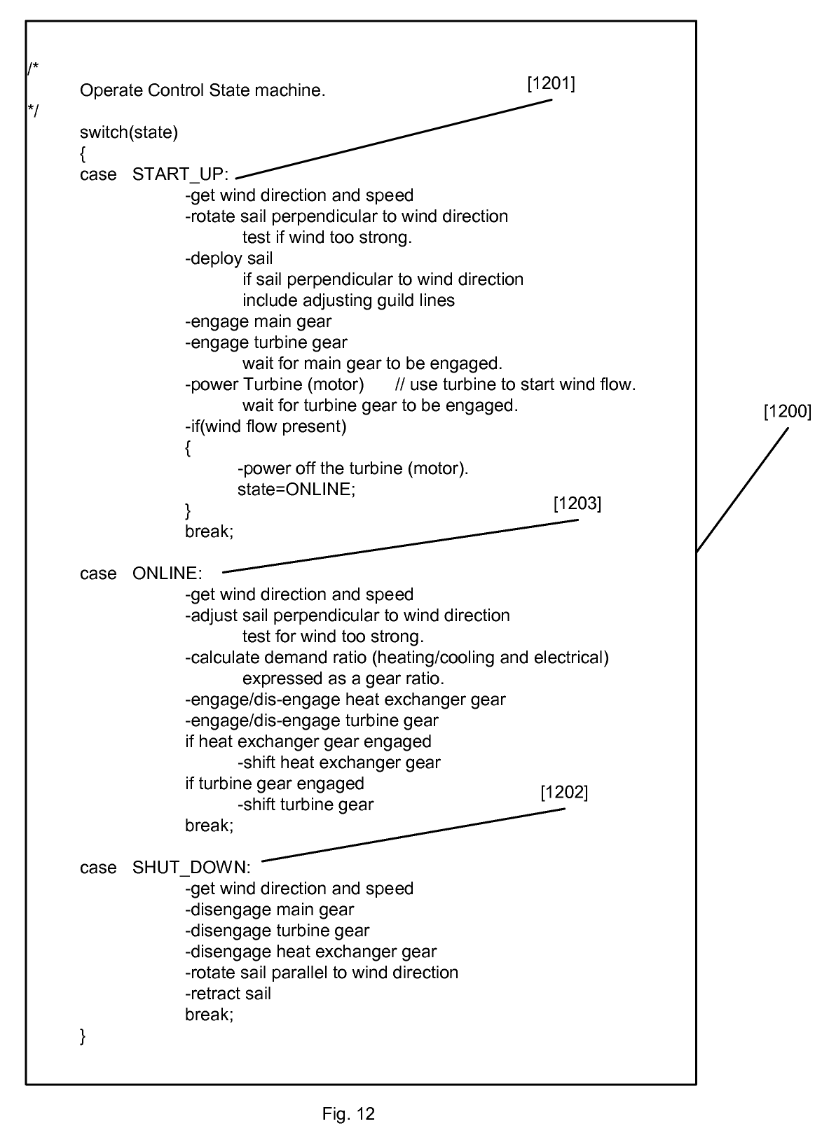

FIG. 12 is a flowchart describing the algorithm [1200] used by the controller. The algorithm is a state machine which operates in 3 states {Start Up [1201], Shut Down [1202], Online [1203]}. In the start up state the controller performs all operations which are required to take the wind dam from the shut down state to the online state where the wind dam is ready to convert wind energy into heating/cooling or electricity. In the Shut Down state the controller performs all operations required to take the wind dam from the online state to the shut down state where the sail is retracted and no wind energy is being captured. In the Online state the controller performs all operations which are required to optimally convert wind energy into heating/cooling or electricity. The Wind Dam also includes a Fail Safe mechanism which in the event of a controller failure will put the Wind Dam into a Shut Down state (i.e. with the Sail rotated parallel to wind direction and sail retracted). The Fail Safe state is the default orientation of the sail controlled mechanically by the wind vane and wind flaps and the default state of the sail (i.e. retracted) controlled by the guide wire stress controller.

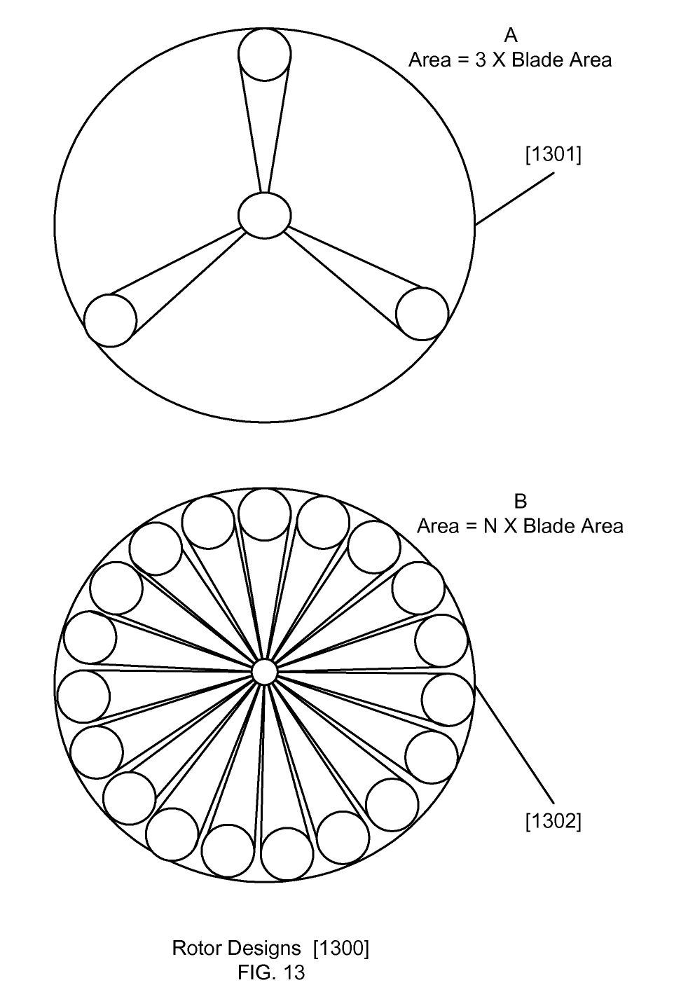

FIGS. 13a and 13b are diagrams illustrating two Rotor configurations [1300]. A first rotor [1301] is a traditional wind generator Rotor configuration used in conventional wind generators with three Blades. A rotor [1302] is a Rotor configuration used by the Wind Dam with greater than three Blades. The amount of wind energy converted by the Rotor is proportional to the area of the Blades and so the larger the area of the Blades (i.e. the more Blades) the more energy may be extracted from the wind. In some prior art wind generators the weight of the Rotor is the limiting factor and so typically only three blades are used. In a wind dam configuration the amount of wind energy captured is proportional to the size of the sail and so the Rotor may be much smaller (i.e. lighter). The wind dam Rotor is relatively small and so more blades can be used to increase the efficiency. In some prior art Rotor configurations the number of blades are chosen to be an odd number (eg. 3) in order to cancel oscillation, in the wind dam configuration the rotor may be constructed of a large number of blades and so it is advantageous to choose a large prime number of blades {5; 7, 11, 13, 17, 19 . . . } in order to inhibit oscillation. Also the Rotor in the wind dam configuration can be made of lighter and stronger materials and be more precisely manufactured.

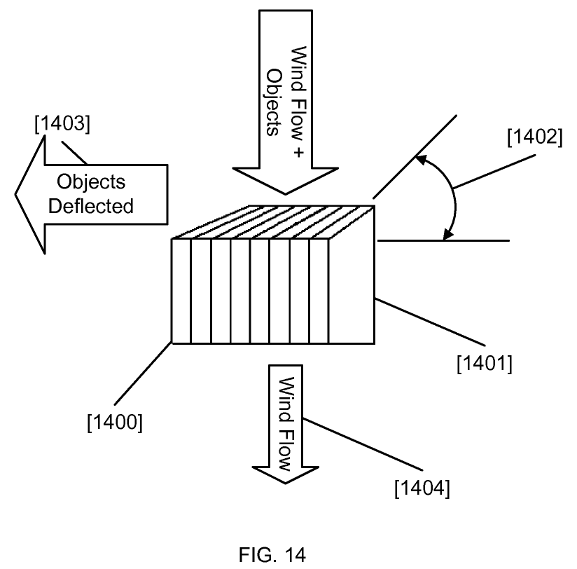

FIG. 14 is a diagram illustrating the Protective Grill [1400] which is positioned at the base of the sail [306]. The Grill is made of several parallel plates [1401] with a small gap between the plates. The top of the plates are angled [1402] in such a way as to deflect any objects [1403] which are larger then the spacing between the plates but allow the wind to flow through [1404] the grill. The protective grill may alternatively be any protective cover that has apertures to permit air passage therethrough while preventing objects larger than the aperture size to pass through.

FIG. 15 is a diagram illustrating of Exhaust Wind Guide [1500] which directs exhausted wind [1501] from the wind dam to the rear of the sail [1502]. In this way the exhaust wind creates back pressure [1503] on the rear of the sail which at least partially balances the wind pressure on the front [1504] of the sail. This is a useful effect because it reduces the stress on the sail itself and allows the sail to be constructed of lighter materials. There is a Rudder above the Exhaust Wind Guide which may also be selectively pivoted in order to dynamically direct more exhaust wind to either side of the sail. This has the effect of generating a force perpendicular to the direction of the wind. This perpendicular force is used by the sway dampening mechanism used to cancel building oscillations.

In the preceding detailed description of the figures, reference have been made to the accompanying drawings which form a part thereof, and to which show by way of illustration specific embodiments in which the invention may be practiced. It will be appreciated that many other varied embodiments that incorporate the teachings herein may be easily constructed by those skilled in the art. Accordingly, the present disclosure is not intended to be limited to the specific form set forth herein, but on the contrary, it is intended to cover such alternatives, modifications, and equivalents, as can reasonably be included within the spirit and scope of the invention.

1. A Wind Dam device comprising:
a wind capture mechanism; and
an energy conversion portion,
wherein the wind dam is appropriate for one or more of: installation on a building; installation in an urban environment; operation for efficient conversion of wind energy to one or more of heating, cooling and electricity; inexpensive construction; operation in a wide range of wind conditions; and, operation in a high population density area.

2. The Wind Dam device as in claim 1, wherein the Wind Capture mechanism comprises a sail.

3. The Wind Dam device as in claim 1, wherein the energy conversion portion comprises a rotor positioned to receive wind and rotate as a result of wind directed thereto from the wind capture mechanism.

4. The Wind Dam device as in claim 3, wherein the rotor is operatively connectable to a heat exchanger.

5. The Wind Dam device as in claim 1, which is appropriate for;
installation in cities;
on the roof of a building;
wherein the wind dam optionally provides one or more of heating, cooling and electricity.

6. The Wind Dam device as in claim 2, wherein said sail is manufactured of fabrics such as canvas or nylon or plastic is used to trap wind energy.

7. The Wind Dam device as in claim 2, wherein said sail includes Guide Wires which are used to retract or deploy the Sail.

8. The Wind Dam device as in claim 2, wherein said sail includes wind release flaps which are used to release wind energy in high wind cases.

9. The Wind Dam device as in claim 2, wherein said Exhaust Wind Guide is used to direct exhaust wind energy to the rear of the Sail.

10. The Wind Dam device as in claim 2, wherein said Rudder is used to direct exhaust wind energy to either side of the sail.

11. The Wind Dam device as in claim 2, wherein said main mast is manufactured as a hollow metal tube which is affixed at the base and is used to enclose guide wires which suspend the Sail.

12. The Wind Dam device as in claim 2, wherein said spar is manufactured as a hollow metal tube which is affixed to the main mast and is used to enclose guide wires which suspend the Sail.

13. The Wind Dam device as in claim 2, wherein said wind vane is used to measure wind direction and wind speed and will by default operate to rotate the sail parallel to the wind direction in the fail safe condition.

14. The Wind Dam device as in claim 4, wherein said heat exchanger is a heat pump driven by wind energy and is used for heating or cooling of a building.

15. The Wind Dam device as in claim 3, wherein the rotor is operatively connectable to an electrical generator.

16. The Wind Dam device as in claim 15, wherein said electrical generator is usable to produce electrical power for use by a building or power grid.

17. The wind Dam device as in claim 2, further comprising a Sail Rotation mechanism.

18. The Wind Dam device as in claim 17, wherein said Rotation Mechanism is used to rotate the sail to control the orientation of the sail.

19. The Wind Dam device as in claim 3, further including adjustable gears used to direct a variable amount of mechanical energy from the Rotor to the heat exchanger and/or the electrical generator.

20. The Wind Dam device as in claim 3, wherein said Rotor mechanism includes a plurality of blades which is a prime number of blades which are used to convert wind energy into mechanical energy.

21. The Wind Dam device as in claim 3, further including a conduit passing from the wind capture mechanism to the rotor, wherein, in use, the conduit includes a downwardly extending portion upstream from an upwardly extending portion.

22. The Wind Dam device as in claim 21, further including a drain at the bottom end of a downwardly extending portion.

23. The Wind Dam device as in claim 21, wherein the conduit is U-shaped.

24. The Wind Dam device as in claim 21, further including a drain at the bottom end of a downwardly extending portion.

25. The Wind Dam device as in claim 21, further comprising a siphon tube to draw air from the conduit to the heat exchanger to urge gas in the heat exchanger through the heat exchanger.

26. The Wind Dam device as in claim 3, further comprising a Protective cover downstream from the wind capture mechanism and upstream from the rotor, wherein the protective cover includes apertures therethrough of a selected size to permit air flow therethrough while preventing objects of a selected size to pass therethrough.

27. The Wind Dam device as in claim 26, wherein said protective cover includes metal plates placed parallel to each other and is used to prevent objects from entering the intake of the wind dam.

28. The Wind Dam device as in claim 1, further comprising a controller and at least one sensor configured to sense at least one of wind speed, wind direction, wind flow, building temperature, ambient temperature and guide wire tension.

29. The Wind Dam device as in claim 1, further comprising a controller that is configured to perform at least one of the following functions: engage/disengage the main gear, set the main gear ratio, to engage/disengage the heat exchanger gear, set the heat exchanger gear ratio, engage/disengage the turbine gear, set the turbine gear ratio, rotate the sail, deploy/retract the sail and select the heating/cooling mode of the heat exchanger.

30. The Wind Dam device as in claim 1, further including a controller which monitors a sensor (as per claim 28) and which performs actions which result in actuating controls (as per claim 29) in order to operate the wind dam in order to achieve cooling/heating or power generation.

31. The Wind Dam device as in claim 1, further including a controller, wherein if said controller fails to operate then the wind dam will automatically go to a fail safe configuration.

32. The Wind Dam device as in claim 1, wherein the installation of the wind dam as in claim 5 permits but is not limited to installation of a wind dam within cities.

33. The Wind Dam device as in claim 1, installed on the roof of a building.

34. The Wind Dam device as in claim 1, wherein provide heating/cooling and optionally generate electricity as in claim 5 generates heating or cooling for a building and/or generates electricity.

35. The Wind Dam device as in claim 2, wherein the wind capture mechanism is selectively adjusted to selectively generate forces in a selected direction relative to the direction of building oscillation to dampen building oscillation of a building on which the wind dam may be positioned.

36. The Wind Dam device as in claim 2, wherein the wind capture mechanism further includes at least one Wind Flap.

37. The Wind Dam device as in claim 2, wherein the wind capture mechanism further includes an Exhaust Wind Guide.

38. The Wind Dam device as in claim 2, wherein the wind capture mechanism further includes a Rudder.

39. The Wind Dam device as in claim 2, wherein the wind capture mechanism further includes a wind vane.

40. The Wind Dam device as in claim 4, wherein the rotor is operatively connectable to an electrical generator, and is selectively operatively connectable to none, one or both of the heat exchanger and the electrical generator.

41. The Wind Dam device as in claim 3, wherein, in use, the Protective cover includes angled members to deflect objects off of the protective cover thereby inhibiting the objects from obstructing air flow through the apertures.

42. The Wind Dam device as in claim 3, wherein the wind capture mechanism is selectively orientable to dampen building sway of a building on which the wind dam may be positioned.
